(19) United States
(12) Patent Application Publication
(10) Pub. No.: US 2006/0037353 A1
(43) Pub. Date: Feb. 23, 2006

(54) Temperature controlled liquid dispenser

(75) Inventors: Tony J. Smestad, Coon Rapids, MN (US); Dennis E. Saathoff, Hudson, WI (US); Mark T. Manders, Lino Lakes, MN (US); Roger J. Bauer, Woodville, WI (US)

Correspondence Address: IPLM GROUP, P.A., POST OFFICE BOX 18455, MINNEAPOLIS, MN, 55418, US

(73) Assignee: Nor-Lake, Incorporated

(21) Appl. No.: 10/924,278

(22) Filed: Aug. 23, 2004

(51) Int. Cl. B67D 5/62

(52) U.S. Cl. 62/389; 222/146.6

(57) ABSTRACT

A preferred embodiment temperature controlled liquid dispenser for dispensing a liquid in a container having a delivery tube includes a cabinet, a compartment within a cavity of the cabinet, and a valve assembly within the compartment. The cabinet has a temperature controlled cavity configured and arranged to contain the container of liquid, and the delivery tube of the container of liquid extends through the compartment within the cavity. The valve assembly within the compartment acts on the delivery tube to control flow of the liquid out of the delivery tube, wherein the container of liquid and the delivery tube proximate the valve assembly are temperature controlled within the cavity.

### BACKGROUND OF THE INVENTION

1. Field of the Invention

The present invention relates to a temperature controlled liquid dispenser for a liquid such as milk dispensed from a container through a delivery tube.

2. Description of the Prior Art

Cafeterias, restaurants, and other establishments where beverages are served commonly dispense beverages from bulk liquid dispensers. One type of beverage that may be dispensed in bulk is milk, which must be maintained at a certain temperature range. Milk in bulk is commonly dispensed from a container such as a pouch or a box having a delivery tube extending out of a refrigerated cabinet containing the container of milk. An external valve assembly is located outside of the refrigerated cabinet, and the valve assembly acts on the delivery tube to open and close the passageway of the delivery tube. One way this is achieved is to pinch the delivery tube so as to close the passageway and prevent milk from flowing through the passageway. When it is desired to dispense the milk, the passageway is released and milk is allowed to flow through the passageway.

Because the milk in the container is stored within the refrigerated cabinet, the milk in the container is kept within the desired temperature range. However, the milk within the delivery tube proximate the valve assembly is not kept within the desired temperature range because it is external to the refrigerated cabinet. It is desired to also keep the milk within delivery tube within the desired temperature range. A copper wire or an aluminum cooling plate is commonly thermally connected to the refrigerated cabinet and placed proximate the delivery tube external to the refrigerated cabinet to keep the milk within the delivery tube within the desired temperature range. One drawback to utilizing a copper wire or an aluminum cooling plate is that the copper wire or the aluminum cooling plate also conducts heat so it is not always as effective as desired. Therefore, it is desired to more effectively keep the milk within the delivery tube within the desired temperature range.

### SUMMARY OF THE INVENTION

A preferred embodiment temperature controlled liquid dispenser for dispensing a liquid in a container having a delivery tube includes a cabinet, a compartment within a cavity of the cabinet, and a valve assembly within the compartment. The cabinet has a temperature controlled cavity configured and arranged to contain the container of liquid, and the delivery tube of the container of liquid extends through the compartment within the cavity. The valve assembly within the compartment acts on the delivery tube to control flow of the liquid out of the delivery tube, wherein the container of liquid and the delivery tube proximate the valve assembly are temperature controlled within the cavity.

Another preferred embodiment temperature controlled liquid dispenser includes a liquid in a container, a cabinet, a compartment within a cavity of the cabinet, and a valve assembly within the compartment. The container has a delivery tube with an upper portion, a pinch portion, and a lower portion. The pinch portion is flexible. The cabinet has a temperature controlled cavity configured and arranged to contain the container of liquid. The delivery tube of the container of liquid extends through the compartment within the cavity. The valve assembly within the compartment has a first position and a second position, and the valve assembly acts on the delivery tube proximate the pinch portion to control flow of the liquid out of the delivery tube. The first position prevents flow out of the delivery tube proximate the pinch portion, and the second position allows flow out of the delivery tube proximate the pinch portion. The valve assembly pinches the delivery tube proximate the pinch portion within the compartment in the first position thereby preventing flow of the liquid within the compartment so that the upper portion of the delivery tube contains liquid and the lower portion of the delivery tube is substantially empty of liquid. The liquid within the upper portion is within the compartment and is temperature controlled.

Another preferred embodiment temperature controlled liquid dispenser includes a liquid in a container having a delivery tube, a cabinet, a compartment within a cavity of the cabinet, a moveable member, and a stop member. The liquid is contained within the container and is dispensed from the container through the delivery tube, which has an upper portion, a pinch portion, and a lower portion. The pinch portion is flexible. The cabinet has a temperature controlled cavity configured and arranged to contain the container of liquid. The delivery tube of the container of liquid extends through the compartment within the cavity. The moveable member is proximate a back of the compartment and moves between a first position and a second position within the compartment proximate the pinch portion. The stop member is proximate a front of the compartment and proximate the pinch portion. The delivery tube extends between the moveable member and the stop member. The moveable member pushes the pinch portion of the delivery tube against the stop member in the first position thereby preventing flow of the liquid through the delivery tube. In the first position, the upper portion of the delivery tube contains liquid and the lower portion of the delivery tube is substantially empty of liquid. The liquid within the upper portion is within the compartment and is temperature controlled. The moveable member releases the pinch portion of the delivery tube in the second position thereby allowing the liquid to flow out of the delivery tube.

### BRIEF DESCRIPTION OF THE DRAWINGS

FIG. 1 is a front perspective view of a liquid dispenser constructed according to the principles of the present invention;

FIG. 1A is a front perspective view of an enlarged area of the liquid dispenser shown in FIG. 1;

FIG. 2 is a front view of the liquid dispenser shown in FIG. 1;

FIG. 3 is a rear perspective view of the liquid dispenser shown in FIG. 1;

FIG. 4 is a front perspective view of the liquid dispenser shown in FIG. 1 with an exploded view a valve assembly;

FIG. 4A is a front exploded perspective view of an enlarged area of the valve assembly shown in FIG. 4;

FIG. 5 is a front perspective view of another embodiment liquid dispenser constructed according to the principles of the present invention;

FIG. 6 is a front view of the liquid dispenser shown in FIG. 5;

FIG. 7 is a back exploded perspective view of a valve assembly of the liquid dispenser shown in FIG. 5;

FIG. 8 is a front perspective view of the valve assembly shown in FIG. 7; and

FIG. 9 is a side view of a plunger of the liquid dispenser shown in FIG. 5.

### DETAILED DESCRIPTION OF A PREFERRED EMBODIMENT

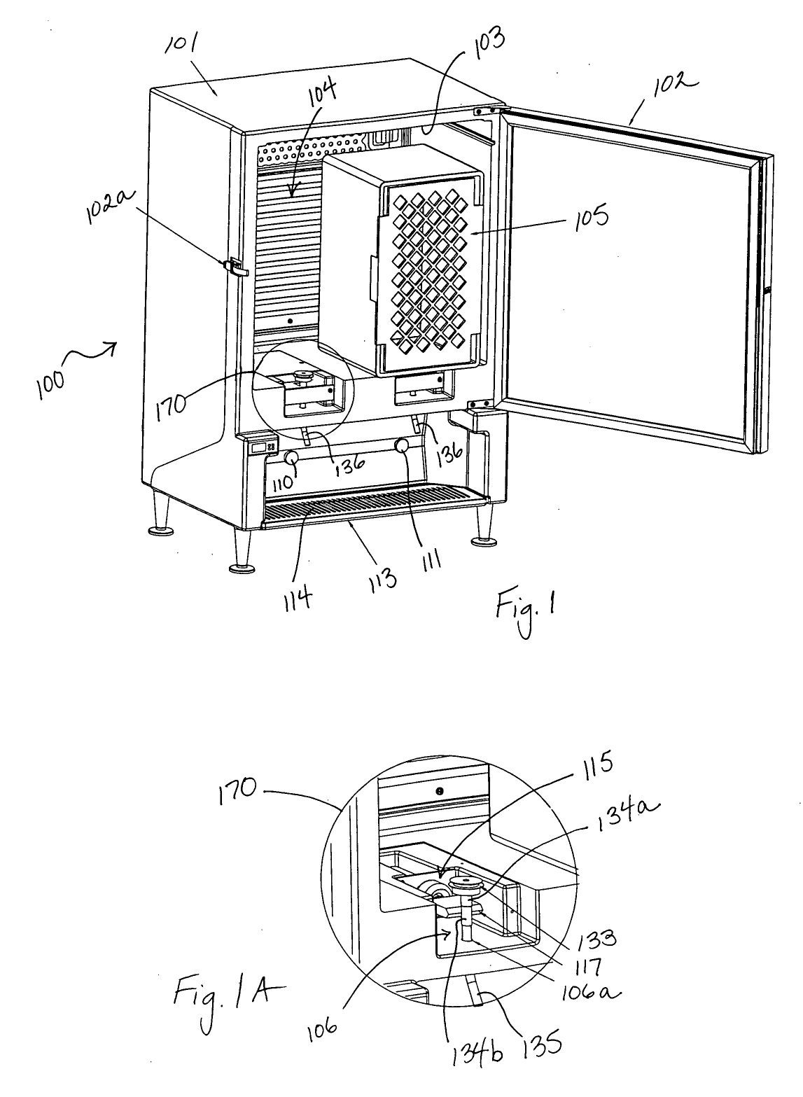

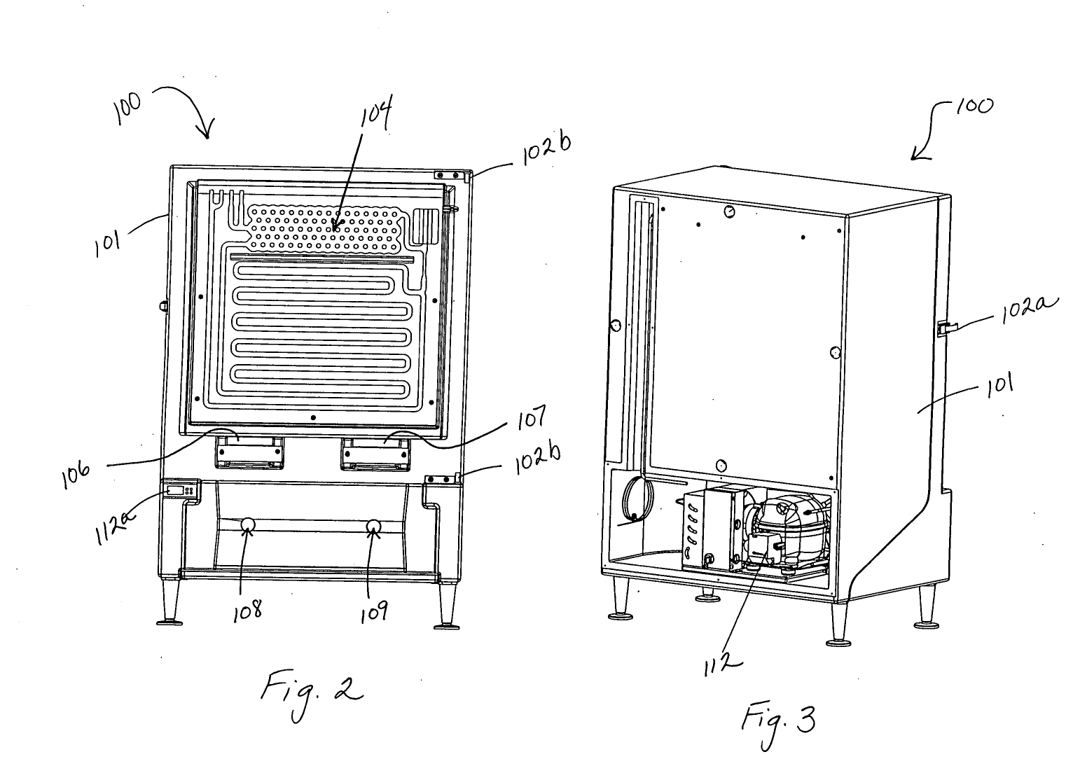

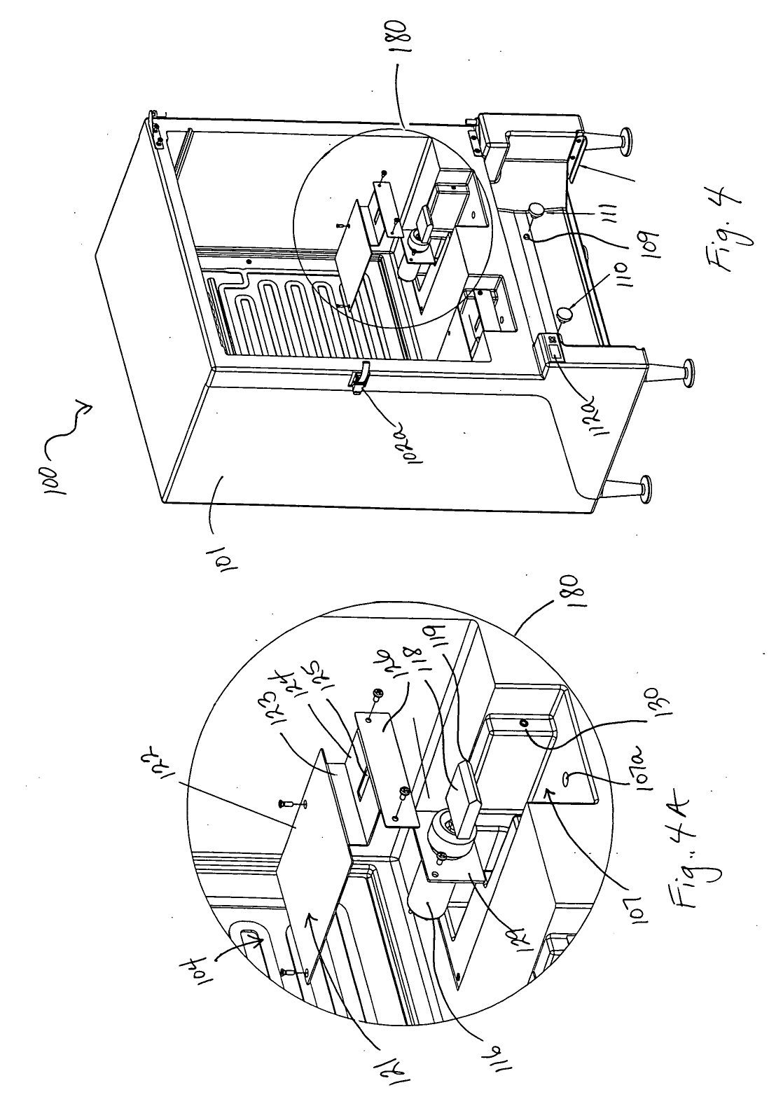

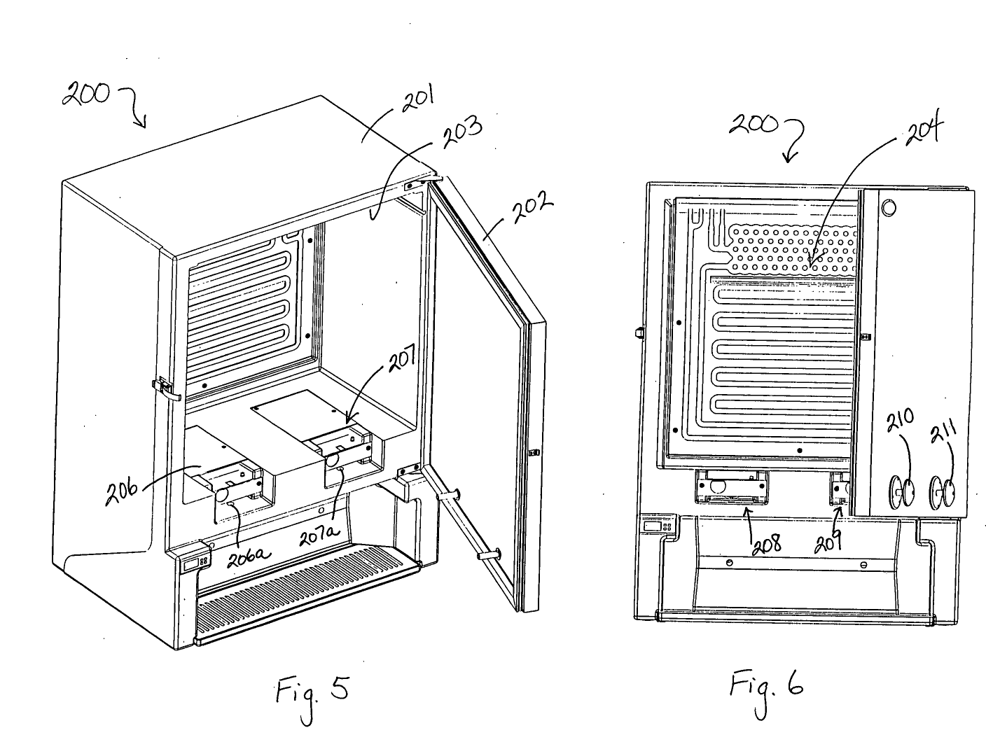

A preferred embodiment temperature controlled liquid dispenser constructed according to the principles of the present invention is designated by the numeral 100 in FIGS. 1-4 and by the numeral 200 in FIGS. 5-6.

The dispenser 100 includes a cabinet 101, which is preferably a five-sided rectangular box roto-molded as one piece as is well known in the art, and a door 102, which is configured and arranged to enclose the open, sixth side of the cabinet 101. The door 102 is preferably the front-facing side of the dispenser 100. The sides of the cabinet 101 define a cavity 103, and the door 102 encloses the cavity 103. Hinges 102b operatively connect the cabinet 101 and the door 102 and allow the door 102 to pivot open and closed relative to the cabinet 101. A latch 102a may be used to lock the door 102 onto the cabinet 101 and is preferably on the side of the door 102 opposite the hinges 102b. The cavity 103 of the cabinet 101 is preferably temperature controlled. A cold plate assembly 104 is preferably placed proximate the side of the cabinet 101 opposite the door 102 and used to maintain a desired cool temperature range within the cavity 103 of the cabinet 101. A condensing unit assembly 112, which is controlled by a temperature control panel 112a, ensures that the cold plate assembly 104 maintains the desired temperature range within the cavity 103. The condensing unit assembly 112 is preferably located proximate the back side of the dispenser 100, and the temperature control panel 112a is preferably located proximate the front side of the dispenser 100. A holding crate 105 may be placed within the cavity 103 to hold a container of a liquid such as milk (not shown) within the cavity 103. Although only one holding crate 105 is shown in FIG. 1, it is recognized that two holding crates 105 are preferably used with dispenser 100. It is also recognized that any number of holding crates may be used, any number from zero to the number of containers of milk to be dispensed from the dispenser 100.

The cavity 103 includes a first compartment 106 and a second compartment 107, which are preferably located proximate the bottom side of the cabinet 101 and the bottom of each of the holding crates 105. The first compartment 106 is configured and arranged to house a first solenoid assembly 115, and the second compartment 107 is configured and arranged to house a second solenoid assembly 116. The bottom of the first compartment 106 includes a bore 106a through which a delivery tube 136 of the corresponding container of milk extends, and the bottom of the second 107 includes a bore 107a through which another delivery tube 136 of the corresponding container of milk extends.

Each delivery tube 136 is operatively connected to the container of milk via a quick connect fitment 133, as shown in FIG. 1A. The delivery tube 136 includes an upper portion 134a, a pinch portion 134b, and a lower dispensing portion 135. The upper portion 134a interconnects the fitment 133 and the pinch portion 134b, and the pinch portion 134b interconnects the upper portion 134a and the lower dispensing portion 135. The pinch portion 134b is preferably flexible and located within the first compartment 106 of the cavity 103. The lower dispensing portion 135 extends through the bore of the first compartment 106 and out of the cavity 103. The front of the dispenser 100 also includes a drip pan 113 having a drip pan grate 114 below the dispensing portions 135 of the delivery tubes 136 to collect any excess liquid dispensed from the dispensing portions 135.

The first compartment 106 and the second compartment 107 are preferably similarly constructed. As shown in FIG. 4A, the second compartment 107 includes a stop assembly mounting surface 130 to which a stop assembly 121 is operatively connected. The stop assembly 121 includes a top plate 122, a connecting plate 123, a dispensing hose through plate 124 having a dispensing hose aperture 125, and a stop member 126. The top plate 122 is preferably a rectangular plate member and extends across a top portion of the second compartment 107. The connecting plate 123 extends preferably perpendicular from the front of the top plate 124, and the connecting plate 123 interconnects the top plate 122 and the dispensing hose through plate 124. The dispensing hose through plate 124 is preferably parallel to the top plate 122 and interconnects the connecting plate 123 and the stop member 126. The dispensing hose aperture 125 is configured and arranged to allow the delivery tube 136 to extend through the dispensing hose aperture 125 within the second compartment 107. The stop member 126 extends preferably perpendicular from the dispensing hose through plate 124 and parallel to the connecting plate 123. The stop member 126 includes apertures aligned with apertures in the stop assembly mounting surface 130 through which fasteners are inserted to operatively connect the stop assembly 121 to the stop assembly mounting surface 130. The pinch portion 134b is preferably proximate the stop member 126.

Generally, a moveable member is proximate the back of the compartment, and the moveable member moves between a first position and a second position within the compartment proximate the pinch portion of the delivery tube. The stop member is proximate the front of the compartment and proximate the pinch portion of the delivery tube on the side opposite of the moveable member. The delivery tube extends between the moveable member and the stop member, and the moveable member pushes the pinch portion of the delivery tube against the stop member in the first position thereby preventing flow of the liquid through the delivery tube. The upper portion of the delivery tube contains liquid and the lower portion of the delivery tube is substantially empty of liquid. The liquid within the upper portion is within the compartment and is temperature controlled, and when the moveable member releases the pinch portion of the delivery tube in the second position, the temperature controlled liquid is allowed to flow out of the delivery tube.

More specifically, the moveable member is preferably a valve assembly proximate each compartment, and the valve assembly acts on the delivery tube to control the flow of liquid through the delivery tube. The valve assemblies, which in this preferred embodiment are operated by solenoid assemblies as is well known in the art, are shown in greater detail in FIGS. 1A and 4A. It is recognized that any suitable moveable member known in the art may be used. The solenoid assemblies are secured within each compartment by a solenoid mounting bracket 129 proximate the middle of each compartment. FIG. 1A is an enlarged view of an area 170 shown in FIG. 1, and FIG. 4A is an enlarged view of an area 180 shown in FIG. 4. As shown in FIG. 1A, the first solenoid assembly 15 includes a solenoid pinch block 117, which acts on the pinch portion 134b of the delivery tube 136 proximate the stop member 126 to open and close the passageway of the delivery tube 136 through which the milk in the container is dispensed. As shown in FIG. 4A, the second solenoid assembly 116 includes a solenoid pinch block 118, which acts on the pinch portion 134b of the delivery tube 136 proximate the stop member 126 to open and close the passageway of the delivery tube 136 through which the milk in the container is dispensed. More specifically, referring to FIG. 4A, the second solenoid assembly 116 includes a solenoid pinch block 118 that moves forward and rearward from a first position to a second position by activation of the solenoid assembly 116 as is well known in the art. The solenoid pinch block 118 has a pinch surface 119, which pushes the pinch portion 134b against the stop member 126 to pinch off flow of liquid through the delivery tube 136 proximate the pinch portion 134b thereby preventing flow of liquid out of the lower dispensing portion 135. In other words, the upper portion 134a of the delivery tube 136 contains liquid and the lower dispensing portion 135 of the delivery tube 136 is substantially empty of liquid. The upper portion 134a containing liquid is within the second compartment 107 and is temperature controlled thereby ensuring that substantially all of the liquid being dispensed from the dispenser 100 is within the desired temperature range. The solenoid pinch block 118 is preferably a rectangular block member, which tapers at one end to form the pinch surface 119.

The valve assemblies, located within the cavity 103 of the milk dispenser 100, are controlled by push button assemblies located proximate the exterior surface of the milk dispenser 100. The first push button assembly 108 activates the first solenoid assembly 115 as is well known in the art. The pinch portion 134b of the delivery tube 136 is preferably made of a flexible material and is positioned between the solenoid pinch block and the stop member of the stop assembly within the compartment of the cavity. When the first push button 110 is pressed inward, the first push button assembly 108 activates the first solenoid assembly 115, which pulls the solenoid pinch block 117 away from the delivery tube 136 to open the passageway of the delivery tube 136 allowing milk to be dispensed therethrough. When the first push button assembly 108 is released, the first solenoid assembly 115 pushes the solenoid pinch block 117 toward the delivery tube 136 to pinch the passageway of the delivery tube 136 closed to stop milk from flowing through the passageway. Similarly, the second push button assembly 109 activates the second solenoid assembly 116 as is well known in the art. When the second push button 111 is pressed inward, the second push button assembly 109 activates the second solenoid assembly 116, which pulls the solenoid pinch block 118 inward to open the passageway of the delivery tube 136 allowing milk to be dispensed therethrough. When the second push button assembly 109 is released, the second solenoid assembly 116 pushes the solenoid pinch block 118 outward to pinch the passageway of the delivery tube 136 closed to stop milk from flowing through the passageway. As shown in FIG. 4A, the stop member 126 provides a surface against which the pinch surface 119 of the solenoid pinch block 118 presses to close the passageway of the delivery tube 136, which is located between the stop member 126 and the solenoid pinch block 118.

Similar to the dispenser 100, the dispenser 200 includes a cabinet 201, which is preferably a five-sided rectangular box roto-molded as one piece as is well known in the art, and a door 202, which is configured and arranged to enclose the open, sixth side of the cabinet 201. The door 202 is preferably the front-facing side of the dispenser 200. The sides of the cabinet 201 define a cavity 203, and the door 202 encloses the cavity 203. Hinges operatively connect the cabinet 201 and the door 202 and allow the door 202 to pivot open and closed relative to the cabinet 201. A latch may be used to lock the door 202 onto the cabinet 201 and is preferably on the side of the door 202 opposite the hinges. The cavity 203 of the cabinet 201 is preferably temperature controlled. A cold plate assembly 204 is preferably placed proximate the side of the cabinet 201 opposite the door 202 and used to maintain a desired cool temperature range within the cavity 203 of the cabinet 201. A condensing unit assembly, which is controlled by a temperature control panel, ensures that the cold plate assembly 204 maintains the desired temperature range within the cavity 203. A holding crate (not shown) may be placed within the cavity 203 to hold a container of a liquid such as milk (not shown) within the cavity 203. It is recognized that any number of holding crates may be used, any number from zero to the number of containers of milk to be dispensed from the dispenser 200.

The cavity 203 includes a first compartment 206 and a second compartment 207, which are preferably located proximate the bottom side of the cabinet 201 and the bottom of each of the containers of milk. The first compartment 206 is configured and arranged to house a first push button assembly 208, and the second compartment 207 is configured and arranged to house a second push button assembly 209. The bottom of the first compartment 206 includes a bore 206a through which a delivery tube of the corresponding container of milk extends, and the bottom of the second 207 includes a bore 207a through which another delivery tube of the corresponding container of milk extends. The first compartment 206 and the second compartment 207 are preferably similarly constructed.

As shown in FIG. 5, the first compartment 206 and the second compartment 207 each include a stop assembly mounting surface to which a stop assembly is operatively connected. Each stop assembly includes a mounting plate assembly 219 and a stop plate assembly 227. The mounting plate assembly 219 includes a bottom plate 220, a U-shaped plate 221, a connecting plate 237, a dispensing hose through plate 238, and a pinch plate 239. The bottom plate 220 is preferably a rectangular shaped plate member configured and arranged to be positioned proximate the bottom of each compartment of the cavity 203. The U-shaped plate 221 includes a first side 226a and a second side 226b interconnected with a mounting surface 226c. The mounting surface 226c is operatively connected to the bottom plate 220 proximate a center portion of the front end of the bottom plate 220. When placed within the compartment, the front end faces the front of the cavity 203 proximate the open side to which the door 202 is operatively connected. The first side 226a includes a first aperture 221a and the second side 226b includes a second aperture 221b. The first side 226a and the second side 226b extend upward from the bottom plate 220, and the first aperture 221a and the second aperture 221b are in alignment with one another. Bushing 222a is placed within aperture 221a and bushing 222b is placed within aperture 221b.

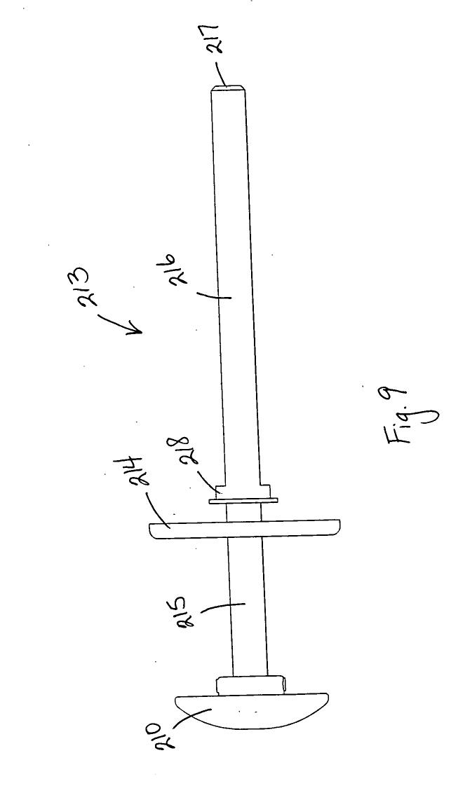

A rod 224 is placed through the apertures 221a and 221b and includes a bore 224a extending laterally through the rod 224 proximate the second aperture 221b. A stop member 225 is inserted through the bore 224a. A biasing member 223, which is preferably a coiled, cylindrical spring with a center bore, extends between apertures 221a and 221b, and the rod 224 extends through the center bore of the biasing member 223. As shown in FIG. 8, the biasing member 223 exerts pressure upon the first side 226a and the stop member 225 thereby biasing the rod 224 in a direction toward the front of the bottom plate 220.

The connecting plate 237 extends upward perpendicular from the front edge of the bottom plate 220 and terminates proximate the second aperture 221b. The dispensing hose through plate 238 extends outward perpendicular from the top edge of the connecting plate 237 and includes aperture 238a and dispensing aperture 238b. The dispensing aperture 238b is preferably in alignment with the rod 224 extending outward from the second aperture 221b proximate the pinch plate 239. The pinch plate 239 extends upward perpendicular from the front edge of the dispensing hose through plate 220 and includes aperture 239a.

The stop plate assembly 227 includes a pinch bracket 228 with a base plate 229, a front plate 230, and a back plate 231. The base plate 229 is preferably configured and arranged to be positioned between the pinch plate 239 and the second side 226b. The base plate 229 includes an aperture 229a in alignment with the aperture 238a and a pinch edge 229b proximate the dispensing aperture 238b. The front plate 230 extends upward perpendicular from the front edge of the base plate 229 proximate the end opposite the end including the aperture 229a. The back plate 231 extends upward perpendicular from the back edge of the base plate 229 proximate the second aperture 221b. The rod 224 is biased to place pressure upon the back plate 231.

A washer 233 is placed between the dispensing hose through plate 238 and the base plate 229. A fastener 232 extends through the aperture 229a and through the washer 233 and is secured by a nut 234. The nut 234 is placed within the aperture 238a to allow the stop plate assembly 227 to pivot relative to the aperture 238a.

Again, as in dispenser 100, a moveable member is proximate the back of the compartment, and the moveable member moves between a first position and a second position within the compartment proximate the pinch portion of the delivery tube. The stop member is proximate the front of the compartment and proximate the pinch portion of the delivery tube on the side opposite of the moveable member. The delivery tube extends between the moveable member and the stop member, and the moveable member pushes the pinch portion of the delivery tube against the stop member in the first position thereby preventing flow of the liquid through the delivery tube. The upper portion of the delivery tube contains liquid and the lower portion of the delivery tube is substantially empty of liquid. The liquid within the upper portion is within the compartment and is temperature controlled, and when the moveable member releases the pinch portion of the delivery tube in the second position, the temperature controlled liquid is allowed to flow out of the delivery tube.

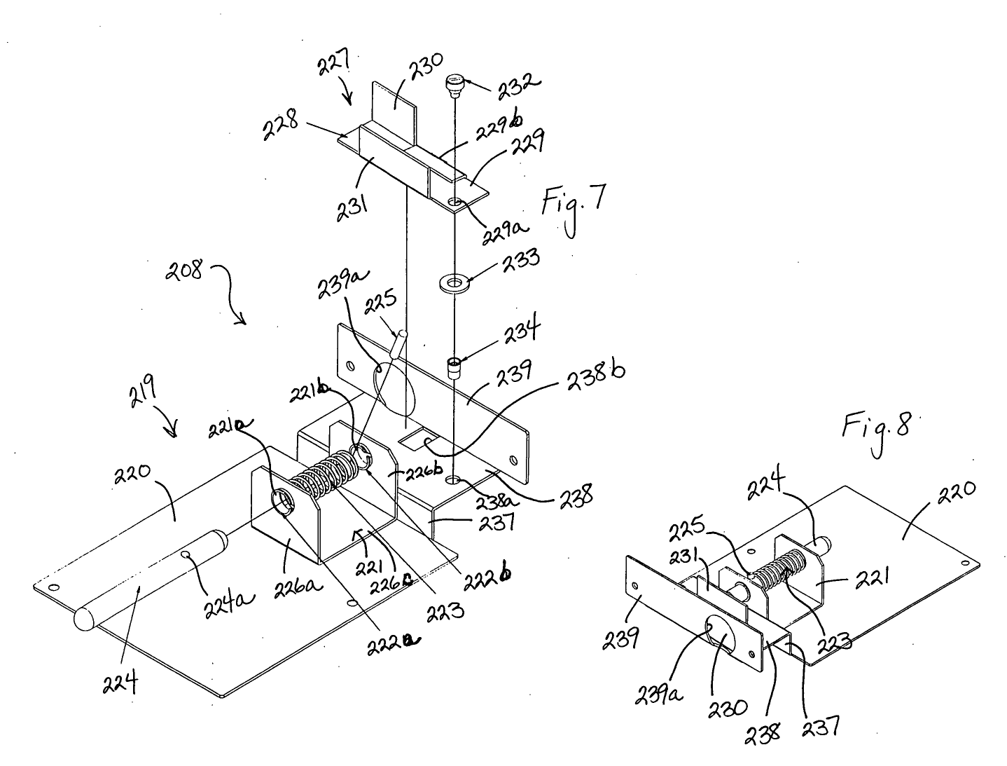

The moveable member is preferably a valve assembly proximate each compartment, and the valve assembly acts on the delivery tube to control the flow of liquid through the delivery tube. The valve assemblies, which in this preferred embodiment are manually operated as is well known in the art, are shown in greater detail in FIGS. 7 and 8. It is recognized that any suitable moveable member known in the art may be used.

The valve assemblies, which in this preferred embodiment are manually operated, are shown in greater detail in FIGS. 7 and 8. A push button 213, shown in FIG. 9, includes a mounting plate 214 with an aperture (not shown) through which a connecting rod 215 is inserted. A first cover 210 is operatively connected to the front end of the connecting rod 215 to provide a surface upon which force may be placed to activate the valve assembly. The back end of the connecting rod 215 is on the opposite side of the mounting plate 214 and is operatively connected to a plunger member 216 including an activating end 217 and a stop 218. The stop 218 prevents the plunger member 216 from going through the aperture in the mounting plate 214, and the activating end 217 extends through aperture 239a to contact the front plate 230. The mounting plate 214 is operatively connected to the front of the door 202 proximate each compartment, as shown in FIGS. 5 and 6. The other valve assembly includes a second cover 211 as shown in FIG. 6.

The delivery tube extends through the dispensing aperture 238b between the pinch edge 229b and the pinch plate 239. In the first position, the rod 224 is biased to place pressure in a forward direction upon the back plate 231, which pivots the pinch bracket 228 forward so that the delivery tube is pinched closed between the pinch edge 229b and the pinch plate 239. Liquid does not flow through the delivery tube in the first position.

In the second position, when force is placed on the first cover 210, the connecting rod 215 and the plunger member 216 are pushed inward toward the cavity 203. The activating end 217 of the plunger member 216 pushes the front plate 230 inward thereby placing pressure in a rearward direction upon the pinch bracket 228, which pivots rearward so that the delivery tube is released and allowed to open. Liquid flows through the delivery tube in the second position. When pressure is released from the first cover 210, the push button 213 and the stop plate 227 are urged into the first position because the rod 224 is continually biased by the biasing member 223.

To comply with NSF regulations, milk should be stored within a temperature range of less than 41° F., more preferably within a range of 33 to 40° F. Not only is the milk stored within the cavity preferably kept within the temperature range of 33 to 40°F., but the milk stored within the cavity proximate the stop assembly is also kept within the temperature range of 33 to 40° F. to comply with NSF regulations. Therefore, because substantially all of the milk stored in the delivery tube during nonuse of the dispenser is kept within the proper temperature range, substantially all of the milk dispensed through the delivery tube is kept within the proper temperature range. This eliminates dispensing warm, potentially spoiled milk from the delivery tube.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A temperature controlled liquid dispenser for dispensing a liquid in a container having a delivery tube, comprising:
a) a cabinet having a temperature controlled cavity configured and arranged to contain the container of liquid;
b) a compartment within the cavity through which the delivery tube of the container of liquid extends; and
c) a valve assembly within the compartment, the valve assembly acting on the delivery tube to control flow of the liquid out of the delivery tube, wherein the container of liquid and the delivery tube proximate the valve assembly are temperature controlled within the cavity.

2. The temperature controlled liquid dispenser of claim 1, wherein a portion of the delivery tube is flexible and the valve assembly pinches the flexible portion of the delivery tube within the compartment thereby stopping flow of the liquid within the compartment, an upper portion of the delivery tube containing liquid and a lower portion of the delivery tube being substantially empty of liquid, the upper portion containing liquid being within the compartment and being temperature controlled.

3. The temperature controlled liquid dispenser of claim 1, wherein the cabinet houses milk and the cavity is cooled.

4. The temperature controlled liquid dispenser of claim 3, wherein the cavity is cooled with a cold plate assembly.

5. The temperature controlled liquid dispenser of claim 1, further comprising:
a) a moveable member proximate a back of the compartment moving between a first position and a second position within the compartment proximate a pinch portion of the delivery tube; and
b) a stop member proximate a front of the compartment and proximate the pinch portion of the delivery tube, the delivery tube extending between the moveable member and the stop member, the moveable member pushing the pinch portion of the delivery tube against the stop member in the first position thereby preventing flow of the liquid through the delivery tube, the upper portion of the delivery tube containing liquid and the lower portion of the delivery tube being substantially empty of liquid, the liquid within the upper portion being within the compartment and being temperature controlled, the moveable member releasing the pinch portion of the delivery tube in the second position thereby allowing the liquid to flow out of the delivery tube.

6. The temperature controlled liquid dispenser of claim 5, wherein the valve assembly is manually operated.

7. The temperature controlled liquid dispenser of claim 5, wherein the valve assembly is operated by a solenoid assembly.

8. A temperature controlled liquid dispenser, comprising:
a) a liquid in a container having a delivery tube, the delivery tube having an upper portion, a pinch portion, and a lower portion, the pinch portion being flexible;
b) a cabinet having a temperature controlled cavity configured and arranged to contain the container of liquid;
c) a compartment within the cavity through which the delivery tube of the container of liquid extends; and
d) a valve assembly within the compartment having a first position and a second position, the valve assembly acting on the delivery tube proximate the pinch portion to control flow of the liquid out of the delivery tube, the first position preventing flow out of the delivery tube proximate the pinch portion, the second position allowing flow out of the delivery tube proximate the pinch portion, wherein the valve assembly pinches the delivery tube proximate the pinch portion within the compartment in the first position thereby preventing flow of the liquid within the compartment, the upper portion of the delivery tube containing liquid and the lower portion of the delivery tube being substantially empty of liquid, the liquid within the upper portion being within the compartment and being temperature controlled.

9. The temperature controlled liquid dispenser of claim 8, wherein the liquid is milk and the cavity is cooled.

10. The temperature controlled liquid dispenser of claim 9, wherein the cavity is cooled with a cold plate assembly.

11. The temperature controlled liquid dispenser of claim 8, wherein the valve assembly is manually operated.

12. The temperature controlled liquid dispenser of claim 8, wherein the valve assembly is operated by a solenoid assembly.

13. A temperature controlled liquid dispenser, comprising:
a) a liquid in a container having a delivery tube, the liquid being contained within the container and being dispensed from the container through the delivery tube, the delivery tube having an upper portion, a pinch portion, and a lower portion, the pinch portion being flexible;
b) a cabinet having a temperature controlled cavity configured and arranged to contain the container of liquid;
c) a compartment within the cavity through which the delivery tube of the container of liquid extends;
d) a moveable member proximate a back of the compartment moving between a first position and a second position within the compartment proximate the pinch portion; and
e) a stop member proximate a front of the compartment and proximate the pinch portion, the delivery tube extending between the moveable member and the stop member, the moveable member pushing the pinch portion of the delivery tube against the stop member in the first position thereby preventing flow of the liquid through the delivery tube, the upper portion of the delivery tube containing liquid and the lower portion of the delivery tube being substantially empty of liquid, the liquid within the upper portion being within the compartment and being temperature controlled, the moveable member releasing the pinch portion of the delivery tube in the second position thereby allowing the liquid to flow out of the delivery tube.

14. The temperature controlled liquid dispenser of claim 13, wherein the moveable member is a manually operated.

15. The temperature controlled liquid dispenser of claim 13, wherein the moveable member is operated by a solenoid assembly.
